(19) United States
(12) Patent Application Publication
(10) Pub. No.: US 2005/0247811 A1
(43) Pub. Date: Nov. 10, 2005

(54) Belt retractor having a pretensioning drive

(75) Inventors: Martin Prokscha, Schwaebisch Gmuend (DE); Wolfgang Holbein, Alfdorf (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive GmbH

(21) Appl. No.: 11/121,657

(22) Filed: May 4, 2005

(30) Foreign Application Priority Data
May 6, 2004 (DE) 10 2004 022 401.3

(51) Int. Cl. B60R 22/46

(52) U.S. Cl. 242/374; 242/390.8

(57) ABSTRACT

A belt retractor for a vehicle safety belt has a frame, a belt reel which is rotatably mounted in the frame, a pretensioning drive which is adapted to drive the belt reel in a wind up direction of the safety belt and in an unwinding direction, and a coupling by means of which the pretensioning drive may be coupled to the the belt reel. The coupling comprises an actuating element which is coupled to the pretensioning drive. When the pretensioning drive is activated, the actuating element is driven in a direction that is opposite to a direction in which a driven member of the coupling is driven.

### BACKGROUND OF THE INVENTION

For improved restraining of a vehicle occupant, belt retractors exist which have a frame, a belt reel which is rotatably mounted in the frame, a pretensioning drive which is adapted to drive the belt reel in a wind up direction of the safety belt and in an unwinding direction, and a coupling by means of which the pretensioning drive may be coupled to the belt reel.

Such a belt retractor is part of an active vehicle occupant restraint system by means of which, upon recognizing a critical vehicle situation, various precautions are taken to protect a vehicle occupant from negative consequences in the best possible way. The measures taken may, for example, include changing the inclination of a back rest of a vehicle seat, closing the vehicle windows, pretensioning the safety belt, and further measures. All these measures are reversible; as soon as the vehicle state that was recognized as being critical does no longer exist, the vehicle is again returned to its initial state. As regards the belt retractor, this means that the safety belt that was wound up by the pretensioning drive upon recognizing a critical vehicle situation to eliminate, as far as possible, the so-called belt slack in the safety belt, is again released, as soon as the vehicle state recognized as being critical does no longer exist. The possibility to actively release the safety belt again and re-establish the original state clearly distinguishes a pretensioning drive from a conventional belt tensioner drive. The latter solely serves to tension the safety belt directly before an accident; no return feature is provided. A further distinction between a conventional belt tensioner drive and a pretensioning drive is the belt webbing force achieved when the safety belt is tensioned. The belt webbing forces generated by a pretensioning drive are several times smaller than those generated by a conventional belt tensioner drive (up to clearly more than 1000 N).

The pretensioning drive usually comprises an electric motor that may be coupled to the belt reel via a reduction gear. The reduction gear is necessary, in order to be able to apply the required torque to the belt reel with a compact electric motor. However, it is due to the reduction gear that the coupling by means of which the electric motor is coupled to the belt reel for the purpose of the pretensioning, is driven with a comparatively low angular velocity. Since, however, a coupling unavoidably has to rotate a predetermined angle until it is transferred from the initial state, i.e. the uncoupled state, to a coupled one, a certain period of time passes necessarily. For obvious reasons, it is to be striven for that this period of time is as short as possible.

It is the object of the invention to further develop a belt retractor of the aforementioned kind to the effect that the pretensioning drive may be coupled to the belt reel via the coupling within a period of time as short as possible.

### BRIEF DESCRIPTION OF THE INVENTION

In order to achieve this object, the invention provides a belt retractor for a vehicle safety belt, having a frame, a belt reel which is rotatably mounted in the frame, a pretensioning drive which is adapted to drive the belt reel in a wind up direction of the safety belt and in an unwinding direction, and a coupling by means of which the pretensioning drive may be coupled to the the belt reel, the coupling comprising an actuating element which is coupled to the pretensioning drive, wherein when the pretensioning drive is activated, the actuating element is driven in a direction that is opposite to a direction in which a driven member of the coupling is driven. The actuating element serves to actively engage the coupling in that for example a coupling disk provided on the coupling is rotated by the actuating element in a direction that is opposite to the direction in which the coupling rotates during the pretensioning action. These two directions of rotation, which are opposite to each other, shorten the period of time that passes until the coupling is engaged. This can be put down to the fact that the angular range which has to be passed through for the engagement does not have to be passed through by the coupling disk alone, but is divided between the coupling moving in the one direction and the coupling disk “moving towards” the coupling. On the assumption that the coupling and the coupling disk rotate with the same angular velocity, the required relative rotation between the coupling and the coupling disk may be passed through in this manner within half the time that was customary before. If the coupling disk is driven with a higher angular velocity, this period of time will further be diminished.

Advantageous designs of the invention will be apparent from the sub-claims.

### BRIEF DESCRIPTION OF THE DRAWINGS

The invention will be described in the following with the aid of a preferred embodiment which is represented in the accompanying drawings, in which:

FIG. 1 shows in a schematic sectional view a belt tensioner comprising a pretensioning drive;

FIG. 2 schematically shows a side view of the gearing used between the pretensioning drive and the belt retractor of FIG. 1;

FIG. 3 shows in an exploded view the coupling used with the belt retractor of FIG. 1;

FIG. 4 shows a section through the coupling shown in FIG. 3;

FIG. 5 shows a side view of the coupling in the initial state; and

FIG. 6 shows a side view of the coupling in the coupled state.

### DETAILED DESCRIPTION OF THE INVENTION

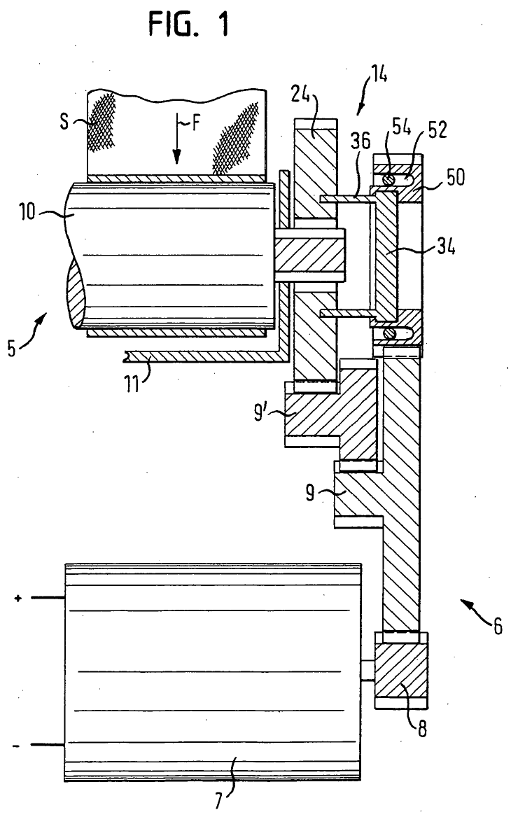

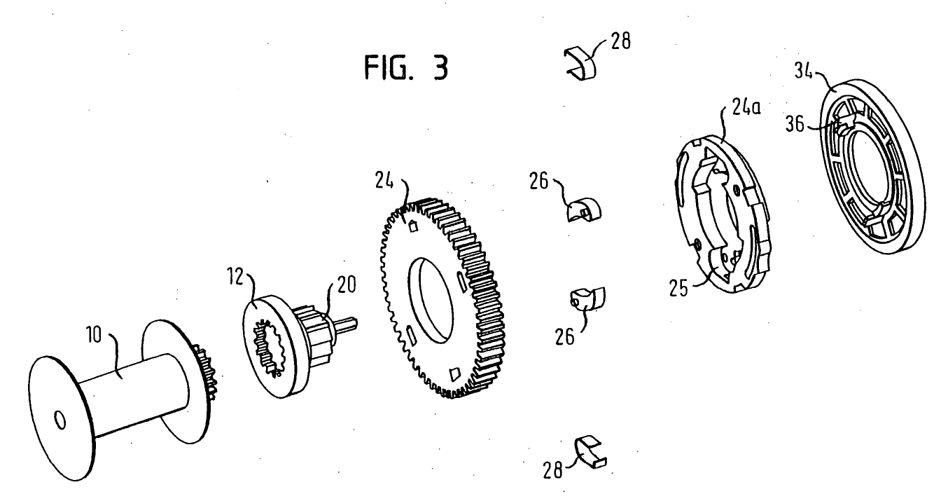

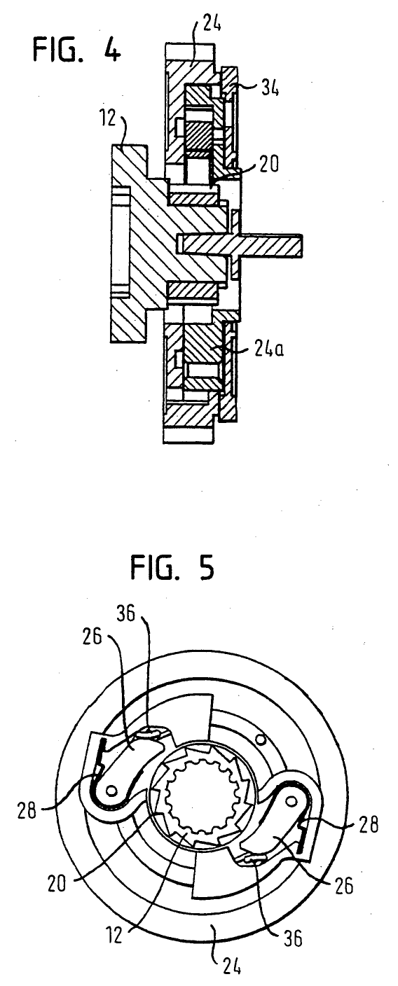

In FIG. 1, there is shown a belt retractor 5 comprising a pretensioning drive 6. The latter consists in particular of an electric motor 7 which is coupled via a reduction gear consisting of a pinion 8 and two stepped gears 9, 9′ to a belt reel 10 of the belt retractor 5. The belt reel is rotatably mounted in a frame 11 and serves to receive a safety belt S that is schematically illustrated. Between the gearing 8, 9 and the belt reel 10, there is provided a coupling 14 which serves to couple the electric motor 7 via the gearing to a belt reel drive member 12 (see FIG. 3) that is non-rotatably connected to the belt reel and comprises a toothing 20.

As an essential component, the coupling 14 (see FIG. 3) comprises a wheel 24 which is provided with an outer toothing that is engaged by the stepped gear 9′ of the gearing. The wheel 24 comprises an insert 24a in which there are formed a plurality of pockets 25, with one pawl 26 each being arranged therein, and a return spring 28 acting on the latter. Each pawl is arranged together with its return spring in one of the pockets 25, and the insert 24a is attached to the wheel, for example locked into place. The pawls are then pivotally received in the respective pocket.

Axially next to the wheel 24, there is arranged a coupling disk 34 provided with control lugs 36 which project through recesses in the insert 24a into the wheel 24, so that they are able to cooperate with the pawls. The coupling disk 34 is provided with a cylindrical outer surface that is received in an actuating element 50 which is embodied in this arrangement as a ring having an outer toothing (see FIG. 1). The actuating element 50 is provided with a circumferential groove 52 extending from one front face, so that the inner circumferential surface resiliently rests against the outer surface of the coupling disk 34. In the groove, there is arranged a spring 54 by means of which the bias and thus also the frictional force between the actuating element 50 and the coupling disk 34 may be adjusted. The outer toothing of the actuating element 50 engages in the toothing of the larger toothed wheel of the stepped gear 9 that meshes with the pinion 8.

In the following the functioning of the coupling 14 will be described.

In the initial position of the coupling (FIG. 5), the pawls 26 are restrained by the return springs 28 in such a manner that they are not in engagement with the toothing 20 of the belt reel drive member 12. In this case the belt reel 10 may rotate freely, and the safety belt S may freely be withdrawn from the belt reel.

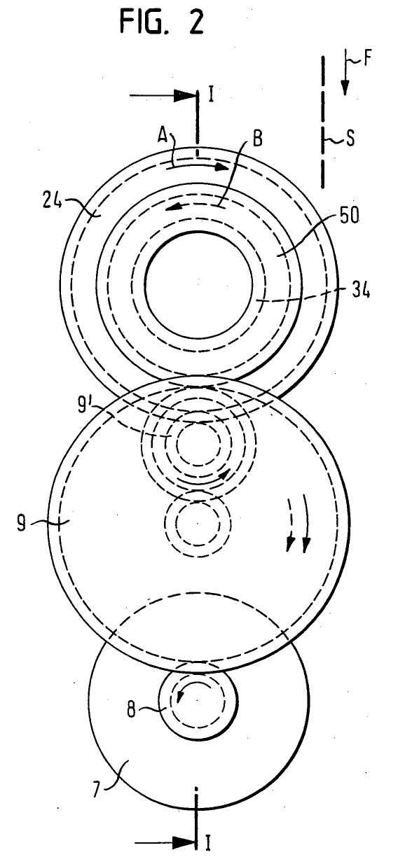

When the belt is to be pretensioned, i.e. it is to be wound up on the belt reel 10 in the direction of the arrow F of FIGS. 1 and 2, the electric motor 7 is actuated, so that the pinion 8 rotates in the direction shown in FIG. 2. This rotation is transferred by the first stepped gear 9 to the second stepped gear 9′ and by the latter to the wheel 24 that rotates in the direction of the arrow A of FIG. 2. At the same time the actuating element 50 is driven in the opposite direction, namely in the direction of the arrow B of FIG. 2, because it is connected to the larger toothed wheel of the first stepped gear 9 and thus “skips” one toothed wheel of the gearing with respect to the belt reel. On account of the frictional force acting between the actuating element 50 and the coupling disk 34, the latter is entrained as well.

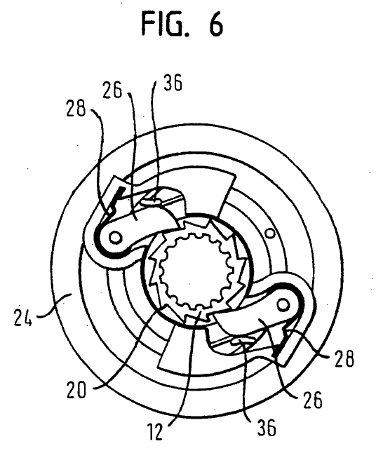

As soon as the wheel 24 is driven, it entrains the pawls 26 arranged therein. At the same time the control lugs 36 are moved towards the pawls 26 by the coupling disk 34, so that the pawls 26 very rapidly ride over the control lugs 36 and are caused to engage in the toothing 20 (see FIG. 6). This takes place in a considerably shorter period of time than with a conventional belt retractor in which the coupling disk 34 is stationarily held with the control lugs 36.

As soon as the pawls 26 are caused to completely engage in the toothing 20, the wheel 24 is coupled to the belt reel 10, and the safety belt may be pretensioned. In so doing, the coupling disk 34 is entrained via the control lugs 36, which is possible without any problems on account of the slip clutch between the coupling disk 34 and the actuating element 50.

In order to release the connection between the wheel 24 and the belt reel 10, the wheel 24 is driven in the opposite direction, so that the control lugs are moved away from the pawls 26; the pawls may then return to their initial position under the effect of the return springs 28.

1. A belt retractor for a vehicle safety belt, having a frame, a belt reel which is rotatably mounted in said frame, a pretensioning drive which is adapted to drive said belt reel in a wind up direction of said safety belt and in an unwinding direction, and a coupling by means of which said pretensioning drive may be coupled to said the belt reel, said coupling comprising an actuating element which is coupled to said pretensioning drive, wherein when said pretensioning drive is activated, said actuating element is driven in a direction that is opposite to a direction in which a driven member of said coupling is driven.

2. The belt retractor of claim 1 wherein said actuating element is a ring which engages a coupling disk.

3. The belt retractor of claim 1 wherein said pretensioning drive includes a reduction gear, said actuating element being driven by said reduction gear.
